(19) United States
(12) Patent Application Publication
(10) Pub. No.: US 2022/0039626 A1
(43) Pub. Date: Feb. 10, 2022

(54) FLOOR CLEANING APPARATUS PRODUCING CLEANING SOLUTION

(71) Applicant: Zenith Technologies, LLC, Fort Lauderdale, FL (US)

(72) Inventor: Mark D. BOSSES, Boca Raton, FL (US)

(21) Appl. No.: 17/394,188

(22) Filed: Aug. 4, 2021

Related U.S. Application Data
(60) Provisional application No. 63/061,067, filed on Aug. 4, 2020.

(51) Int. Cl. A47L 11/40; A47L 11/30; A47L 11/26; C02F 1/461; C02F 1/467; C11D 7/08

(52) U.S. Cl. CPC A47L 11/4083; A47L 11/30; A47L 11/4016; A47L 11/26; C02F 2201/4616; A47L 11/4088; C02F 1/46104; C02F 1/4674; C11D 7/08; A47L 11/4005

(57) ABSTRACT

A floor cleaning apparatus includes a floor cleaning apparatus body. A first tank is removably received by the vacuum cleaner body. A cartridge is removably received by the first tank. The cartridge releasably stores chemical elements. A first electrical contact is disposed in the floor cleaning apparatus body. A second electrical contact is disposed in the first tank. The second electrical contact is electrically connected to the first electrical contact when the floor cleaning apparatus body receives the first tank. Electrical power is configured to be supplied to the first electrical contact to release the chemical elements stored in the cartridge into water stored in the first tank. The supplied electrical power is configured to cause electrolysis of the water and the chemical elements in the first tank to produce a cleaning solution in the first tank.

### CROSS-REFERENCE TO RELATED APPLICATIONS

This application claims the benefit under 35 U.S.C. § 119(e) of U.S. Provisional Application No. 63/061,067, filed Aug. 4, 2020. The entire disclosure of U.S. Provisional Application No. 63/061,067 is hereby incorporated herein by reference.

### BACKGROUND

### Field of the Invention

This invention generally relates to a floor cleaning apparatus. More specifically, the present invention relates to a floor cleaning apparatus that produces cleaning solution for use during operation of the floor cleaning apparatus.

### Background Information

A floor cleaning apparatus uses a cleaning solution to wash and clean surfaces, such as floors and carpets. The floor cleaning apparatus includes a tank that stores the cleaning solution. Prior to operation of the floor cleaning apparatus, a user adds cleaning solution to the first tank from a separate container storing the cleaning solution. During operation of the floor cleaning apparatus, the cleaning solution is dispensed from a nozzle onto the surface to be cleaned.

### SUMMARY

Generally, the present disclosure is directed to a floor cleaning apparatus that produces cleaning solution for use during operation of the floor cleaning apparatus.

In view of the state of the know technology and in accordance with a first aspect of the present disclosure, a floor cleaning apparatus includes a floor cleaning apparatus body. A first tank is removably received by the vacuum cleaner body. A cartridge is removably received by the first tank. The cartridge releasably stores chemical elements. A first electrical contact is disposed in the floor cleaning apparatus body. A second electrical contact is disposed in the first tank. The second electrical contact is electrically connected to the first electrical contact when the floor cleaning apparatus body receives the first tank. Electrical power is configured to be supplied to the first electrical contact to release the chemical elements stored in the cartridge into water stored in the first tank. The supplied electrical power is configured to cause electrolysis of the water and the chemical elements in the first tank to produce a cleaning solution in the first tank.

In view of the state of the known technology and in accordance with a second aspect of the present invention, a floor cleaning apparatus includes a floor cleaning apparatus body. A first tank is removably received by the floor cleaning apparatus body. A second tank is removably received by the floor cleaning apparatus body. The second tank is not in fluid communication with the first tank. A cartridge is removably connected to the first tank. The cartridge releasably stores chemical elements. A first electrical contact is disposed in the floor cleaning apparatus body. A second electrical contact is disposed in the first tank. The second electrical contact is electrically connected to the first electrical contact when the floor cleaning apparatus body receives the first tank. Electrical power is configured to be supplied to the first electrical contact to release the chemical elements stored in the cartridge into water stored in the first tank. The supplied electrical power is configured to cause electrolysis of the water and the elements in the first tank to produce a cleaning solution in the first tank.

In view of the state of the known technology and in accordance with a third aspect of the present disclosure, a cartridge assembly is usable with a floor cleaning apparatus to produce a cleaning solution. A cartridge is configured to be removably received by the floor cleaning apparatus. Chemical elements are releasably stored in the cartridge. The chemical elements are configured to be released when the cartridge is received by the floor cleaning apparatus to produce the cleaning solution.

Also, other objects, features, aspects and advantages of the disclosed floor cleaning apparatus producing cleaning solution will become apparent to those skilled in the art from the following detailed description, which, taken in conjunction with the annexed drawings, discloses several embodiments of a floor cleaning apparatus producing cleaning solution.

### BRIEF DESCRIPTION OF THE DRAWINGS

Referring now to the attached drawings which form a part of this original disclosure:

FIG. 1 is a perspective view of a wet vacuum cleaner assembly in accordance with an exemplary embodiment of the present invention;

FIG. 2 is a perspective view of the wet vacuum cleaner assembly of FIG. 1 in which a first tank is removed from a vacuum cleaner body;

FIG. 3 is a top plan view in partial cross section of the wet vacuum cleaner assembly of FIG. 1 with the first tank removed;

FIG. 4 is a perspective view of the first tank and a cartridge receivable thereby;

FIG. 5 is a perspective view of the wet vacuum cleaner assembly of FIG. 1 with the first tank removed:

FIG. 6 is a side elevational view of the first tank of FIG. 5 with the cartridge received by the first tank;

FIG. 7 is a perspective view of the first tank and the cartridge of FIG. 7;

FIG. 8 is a perspective view of the wet vacuum cleaner assembly of FIG. 1 connected to an electrical outlet;

FIG. 9 is an enlarged perspective view of the first tank received by vacuum cleaner body of FIG. 1:

FIG. 10 is an enlarged perspective view of a handle of the vacuum cleaner body;

FIG. 11 is a perspective view of the wet vacuum cleaner assembly of FIG. 1 indicating a cleaning solution flow path; and

FIG. 12 is perspective view of the wet vacuum cleaner assembly of FIG. 1 indicating a cleaning solution extraction flow path;

FIG. 13 is a top plan view of a first tank in accordance with another exemplary embodiment of the present invention;

FIG. 14 is a side elevational view of the first tank of FIG. 13;

FIG. 15 is a perspective view of the first tank of FIG. 13;

FIG. 16 is a perspective view of a wet mop assembly in accordance with another exemplary embodiment of the present invention;

FIG. 17 is a perspective view of the wet mop assembly of FIG. 16 in which a first tank is removed from a wet mop body;

FIG. 18 is a perspective view of the first tank of FIG. 17 and a cartridge receivable thereby;

FIG. 19 is a partial perspective view of the wet mop assembly of FIG. 16 with the first tank removed;

FIG. 20 is a perspective view of the wet mop assembly of FIG. 16 connected to an electrical outlet;

FIG. 21 is an enlarged perspective view of the first tank received by wet mop body of FIG. 16;

FIG. 22 is a perspective view of the wet mop assembly of FIG. 16 indicating a cleaning solution flow path.

FIG. 23 is perspective view of the wet mop assembly of FIG. 16 indicating a removable pad connected to a base; and

FIG. 24 is an elevational view in cross section of an exemplary embodiment of a cartridge puncturing member.

Throughout the drawing figures, like reference numerals will be understood to refer to like parts, components and structures.

### DETAILED DESCRIPTION OF EXEMPLARY EMBODIMENTS

Selected exemplary embodiments will now be explained with reference to the drawings. It will be apparent to those skilled in the art from this disclosure that the following descriptions of the exemplary embodiments are provided for illustration only and not for the purpose of limiting the invention as defined by the appended claims and their equivalents.

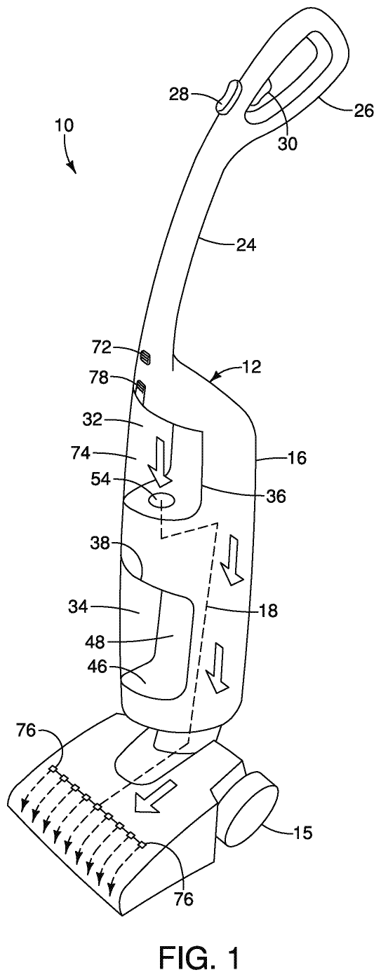

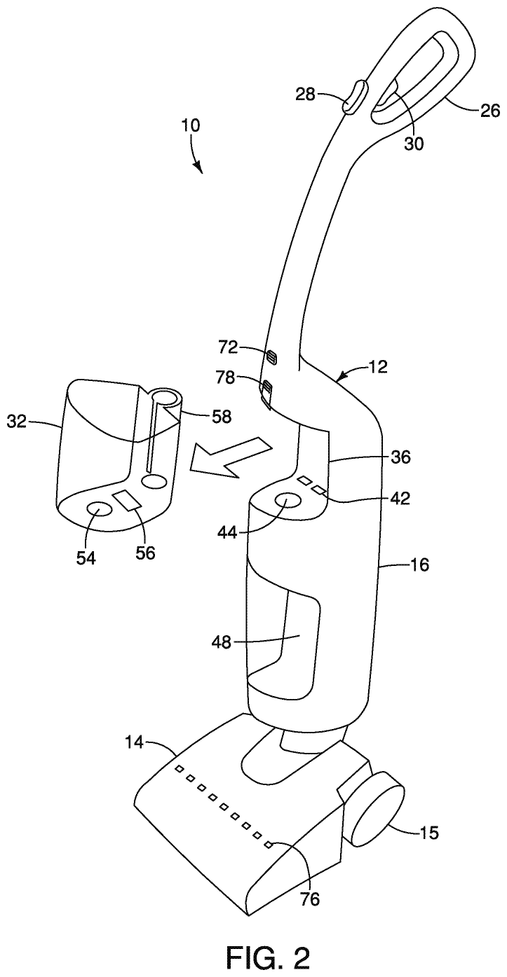

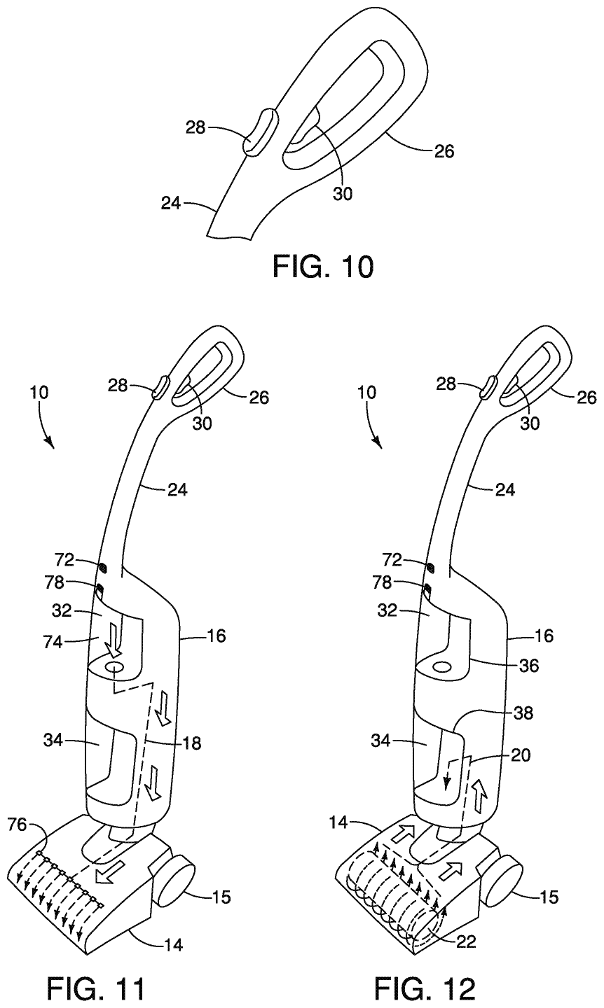

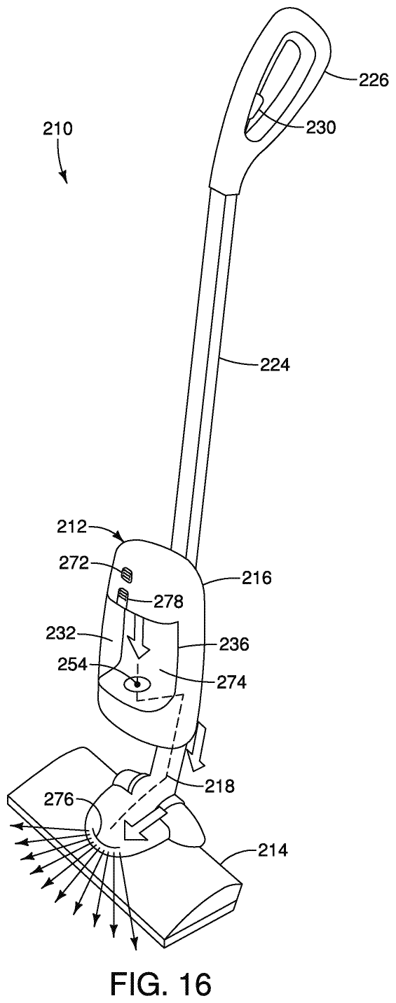

In accordance with exemplary embodiments of the present invention, a floor cleaning apparatus produces cleaning solution for use during operation, or use, of the floor cleaning apparatus. The floor cleaning apparatus includes a floor cleaning apparatus body. A first tank is removably received by the floor cleaning apparatus body. A cartridge is in communication with the first tank. A first set of electrical contacts is disposed in the floor cleaning apparatus body. A second set of electrical contacts is disposed in the first tank. The second set of electrical contacts is electrically connected to the first set of electrical contacts when the flooring cleaning apparatus body receives the first tank. Supplying electrical power to the first set of electrical contacts releases elements stored in the cartridge into water stored in the first tank. The supplied electrical power causes electrolysis of the water and the elements in the first tank to produce a cleaning solution in the first tank. The floor cleaning apparatus can be any suitable type of floor cleaning apparatus, such as, but not limited to, a wet vacuum cleaner assembly or a wet mop assembly. As shown in FIGS. 1-15, the floor cleaning apparatus in accordance with exemplary embodiments of the present invention is a wet vacuum cleaner assembly 10. As shown in FIGS. 16-23, the floor cleaning apparatus in accordance with exemplary embodiments of the present invention is a wet mop assembly 210.

As shown in FIGS. 1-13, a wet vacuum cleaner assembly 10 in accordance with an exemplary embodiment of the present invention includes a vacuum cleaner body 12 and a base 14. The base 14 is pivotably connected to the vacuum cleaner body 12 such that the body 12 can be held at any suitable angle with respect to the base 14.

The vacuum body 12 includes a housing 16 in which a suction motor (not shown) and a power source 75 (FIG. 8) are disposed. The power source, such as a plurality of rechargeable batteries, is electrically connected to and powers the motor. The motor creates a solution extraction path 20 (FIG. 12) through which dispensed cleaning solution and other debris is extracted from the surface being cleaned. The motor further powers a brush roll 22 (FIG. 12) disposed in the base 14. The vacuum body 12 can further include a pump (not shown) that is controlled by the motor to pump cleaning solution through the solution distribution path 18 (FIG. 11) to dispense the cleaning solution 74 stored in a first tank 32. Alternatively, the cleaning solution can be dispensed through a conventional non-powered system.

The vacuum cleaner body 12 includes a handle 24 extending from the housing 16 and includes a gripping portion 26 disposed at an upper end of the handle 24 to facilitate handling the wet vacuum cleaner assembly, as shown in FIG. 1. A power button 28 disposed on the handle 24 turns on and off the power supply of the power source to the motor to control operation of the brush roll 22 and to generate suction. The suction draws up the dispensed cleaning solution and other debris through the solution extraction path 20 (FIG. 12). A trigger 30 is disposed on the handle 24. Operation of the trigger 30 dispenses cleaning solution 74 through the solution distribution path 18 (FIG. 11) and is sprayed out through a plurality of nozzles 76 disposed in the base 14, as shown in FIGS. 1 and 11.

The housing 16 of the vacuum cleaner body 12 includes a first tank 32 and a second, or recovery, tank 34, as shown in FIG. 1. The second tank 34 is not in fluid communication with the first tank 32. Cleaning solution is produced and stored in the first tank 32. Cleaning solution and other debris extracted or drawn up from the surface being cleaned is stored in the second tank 34.

The housing 16 of the vacuum cleaner body 12 includes a first tank receiving portion 36 and a second tank receiving portion 38, as shown in FIG. 1. The first and second tank receiving portions 36 and 38 are recessed portions in the housing 16 configured to removably receive the first and second tanks 32 and 34. The first tank receiving portion 36 is spaced from the second tank receiving portion 38. As shown in FIG. 1, the first tank receiving portion 36 is disposed above the second tank receiving portion 38, although the first and second tank receiving portions 36 and 38 can have any suitable configuration in the housing 16 of the vacuum cleaner body 12.

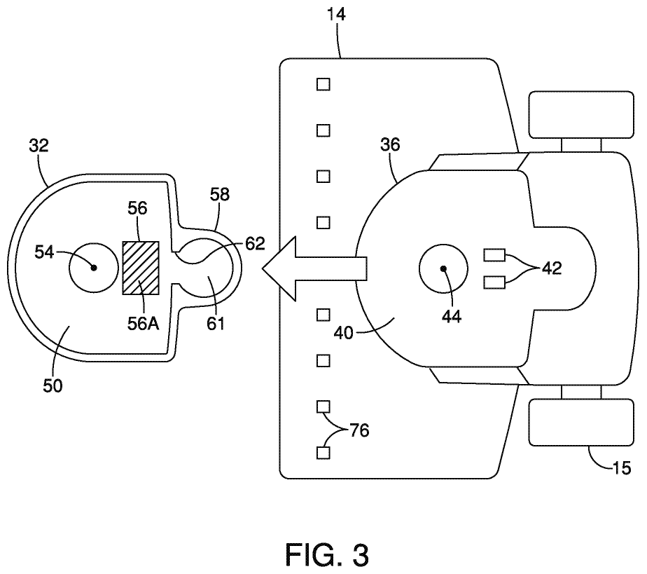

The first tank receiving portion 36 includes a base 40, as shown in FIGS. 3 and 5. A first electrical contact 42 is disposed in the base 40. The first electrical contact 42 is illustrated as a pair of electrical contacts, but can have any suitable configuration. A port 44 is disposed in the base 40 and is in fluid communication with the solution distribution path 18, as shown in FIG. 1.

The second tank receiving portion 38 includes a base 46 and a port 48. The second tank 32 rests on the base 46 of the second tank receiving portion 38. A port 48 is disposed in the body 16 and is in fluid communication with the solution extraction path 20, as shown in FIG. 12.

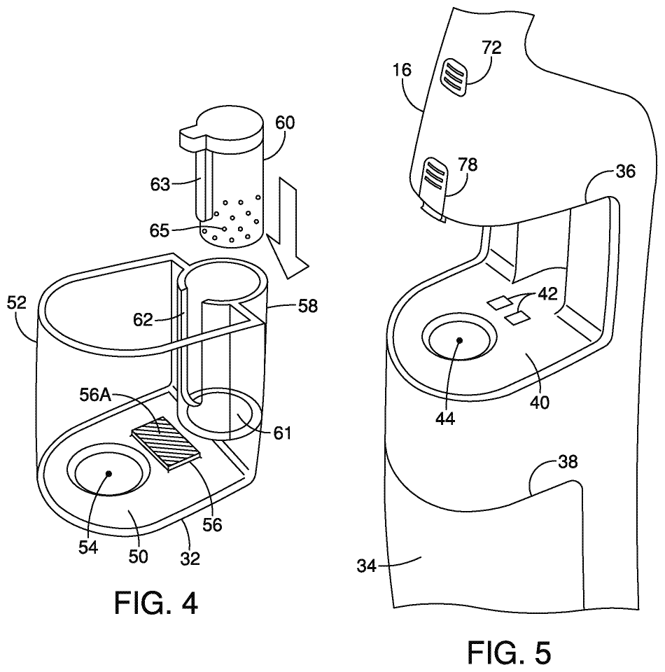

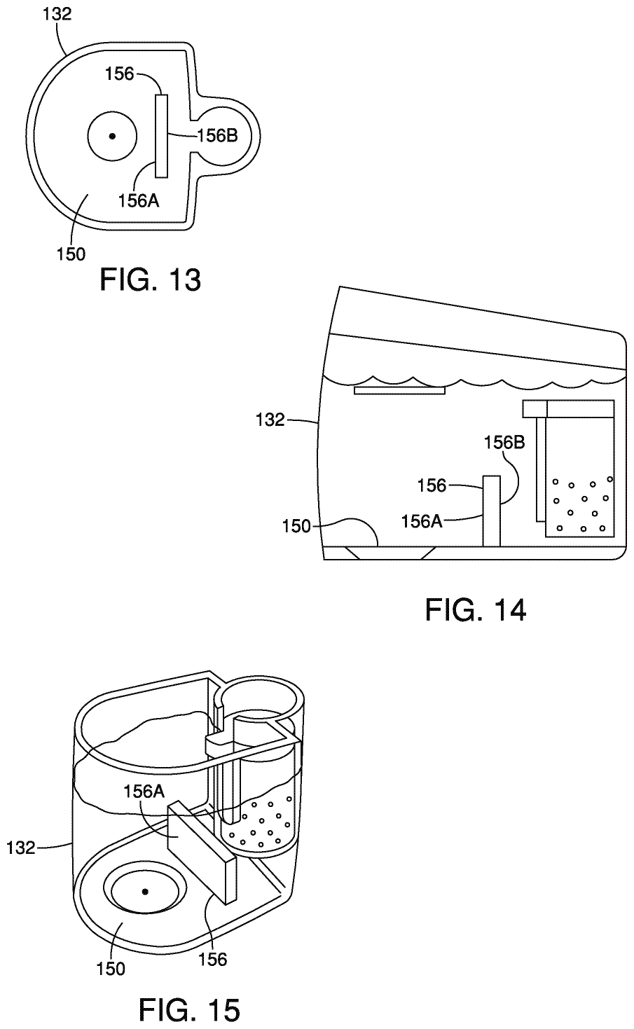

The first tank 32 includes a base 50 and a wall 52 extending upwardly from the base, as shown in FIG. 4. A port 54 in the base 50 of the first tank 32 is aligned with the port 44 in the base 40 of the first tank receiving portion 36, such that the first tank 32 is in fluid communication with the solution distribution path 18 (FIGS. 1 and 11). A second electrical contact 56 is disposed on the base 50 of the first tank 32. The second electrical contact 56 is electrically connected to the first electrical contact 42 when the first tank 32 is received by the first tank receiving portion 36. As shown in FIGS. 4, 6 and 7, the second electrical contact 56 is disposed substantially planar to the base 50, such that the upper surface 56A is exposed. Alternatively, as shown in FIGS. 13-15, the second electrical contact 156 of the first tank 132 can be disposed substantially perpendicular to the base 150, thereby exposing a larger surface area of the second electrical contact 156. Surfaces 156A and 156B of the first electrical contact 156 are exposed when the second electrical contact 156 is disposed substantially perpendicular to the base 150 of the first tank 130.

The wall 52 includes a cylindrical wall portion 58, as shown in FIG. 4. The cylindrical wall portion 58 includes a base 61. A slot 62 extends linearly from the upper end of the cylindrical wall portion 58 towards the base 61. Preferably, the slot 62 does not extend to the base 61.

A cartridge 60 is configured to be received by the cylindrical wall portion 58 of the first tank 32, as shown in FIG. 4. A projection 63 extends outwardly from an outer surface of the cartridge 60 and has a shape corresponding to a shape of the slot 62, thereby ensuring proper alignment of the cartridge 60 with the first tank 32. The cartridge 60 contains chemical elements, such as a saline solution. Alternatively, the cartridge 60 is removably received by the housing 16 of the vacuum cleaner body 12 such that the cartridge 60 is in communication with the first tank 32. In other words, the cartridge 60 is received by the housing 16 externally of the first tank 32.

The power source 75 is disposed in the vacuum body housing 16 and is configured to be connected to an external power supply 64, such as an electrical outlet, to charge the power source, as shown in FIG. 8. A power cord 66 is connected between a port in the base 14 of the wet vacuum cleaner assembly 10 and the external power supply 64 to supply power from the external power supply 64 through the power cord 66 to charge the power source. The port is electrically connected to the power source. The power cord 66 is removed from the port and the external power supply 64 when the power source is charged to a desired level. An indicator can be disposed on the vacuum body housing 16 to indicate when the power source is fully charged.

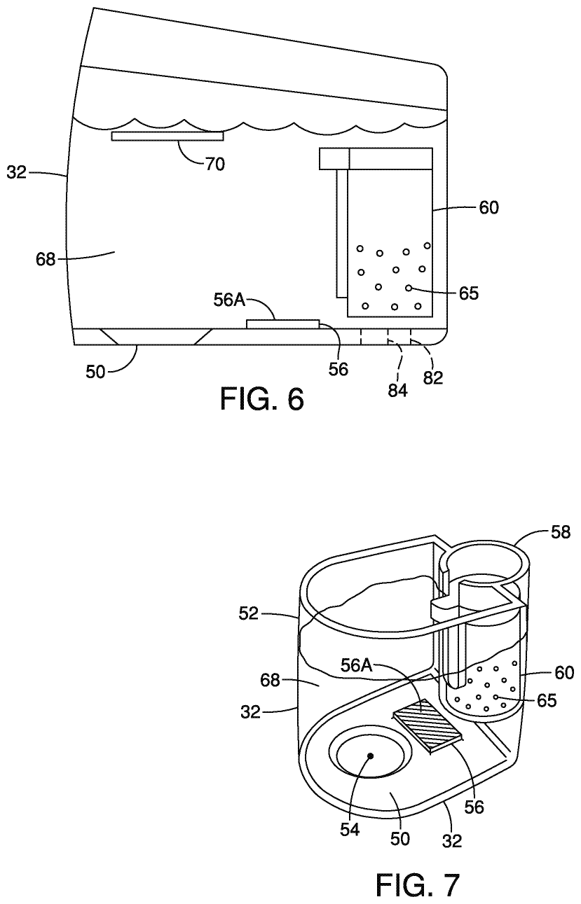

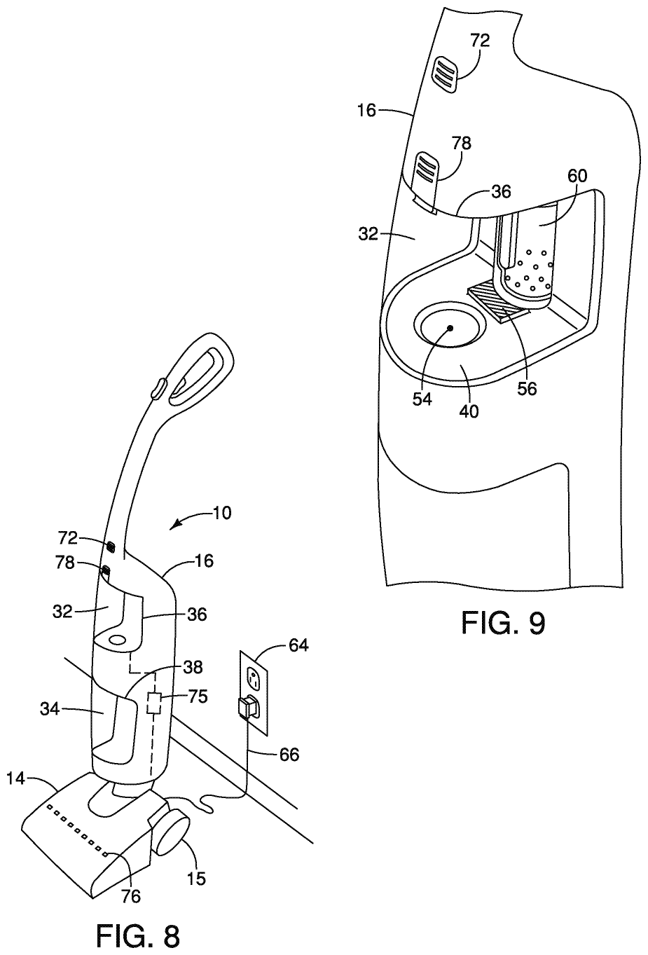

The first tank 32 is removed from the first tank receiving portion 36 to add a cartridge 60 to the first tank 32. Pressing a locking button 78, as shown in FIGS. 5 and 8, on the housing 16 allows the first tank 32 to be removed from the first tank receiving portion 36. When the cartridge 60 is received by the first tank 32, water 68 is added to the first tank 32 to a fill line 70, as shown in FIGS. 6 and 7. The first tank 32 is then positioned in the first tank receiving portion 36, as shown in FIG. 8. The locking member 78 flexes to allow insertion of the first tank 32, and then securely retains the first tank 32 in the first tank receiving portion 36 and prevents accidental removal of the first tank 32. An upper wall of the first tank receiving portion 36 covers and seals the first tank 32 to substantially prevent contents thereof from leaking or splashing out. Alternatively, the first tank can be provided with a removable cover. The power cord 66 is connected between the wet vacuum cleaner assembly 10 and the external power supply 64. A solution producing button 72 is disposed on the housing 16 of the wet vacuum cleaner assembly 10, as shown in FIGS. 5 and 9.

When the power cord 66 supplies electrical power from the external power source 64 to the vacuum cleaner assembly 10, the solution producing button 72 can be pressed to produce cleaning solution 74 in the first tank 32. Power is supplied to the second electrical contact 56 disposed in the first tank 32 through the first electrical contact 42 in the housing 16 of the vacuum cleaner body 12. Power being supplied to the first electrical contact causes chemical elements 65 in the cartridge 60 to be released into the first tank 32. A projection 84 disposed in a puncture member 84 disposed in the base 50 of the first tank is caused to move upwardly and puncture a seal formed at the bottom of the cartridge 60. The puncture member 84 can be electrically activated by the power supplied to the second electrical contact 56 in the first tank 32. The projection 84, such as a needle, is activated by the supply of electrical power to the second electrical contact 56. Alternatively, the puncture member can be disposed in in the base 40 of the first tank receiving portion 36. As shown in FIG. 24, the puncture member 284 can be mechanically activated. The puncture member 84 can be activated in any suitable member that punctures the cartridge 60 to release the chemical elements stored therein.

Alternatively, the chemical elements can be released without a puncture member. The cartridge can include a water soluble membrane that dissolves when water contacts the water soluble membrane in the first tank to release the chemical elements stored therein.

The puncture member 84 allows the chemical elements 65 stored in the cartridge to leak into the first tank 32 and mix with the water 68 (FIGS. 6 and 7) stored therein. The electrical power supplied to the second electrical contact 56 causes electrolysis to occur, thereby creating the cleaning solution 74 in the first tank 32. For example, the cartridge 60 can contain a liquid saline solution, which is mixed with the water 68 stored in the first tank 32. Electrolysis produces a hypochlorous acid, which can be used as the cleaning solution 74 with the wet vacuum cleaner assembly 10. The cleaning solution 74 is produced in the first tank 32 in the wet vacuum cleaner assembly 10, such that the cleaning solution does not need to be added to the first water tank 32. When the wet vacuum cleaner assembly 10 is sufficiently charged and electrolysis is complete, the power cord 66 can be unplugged from the external power source 64 and the wet vacuum cleaner assembly 10, including the produced cleaning solution 74, is ready for operation. Alternatively, the cleaning solution can be produced without the wet vacuum cleaner assembly 10 being connected to the external power source 64 (FIG. 8). In other words, the cleaning solution can be produced when the wet vacuum cleaner assembly 10 is not being charged. The power required for electrolysis is supplied from the power source 75 of the wet vacuum cleaner assembly 10, as shown in FIG. 8.

The motor of the wet vacuum cleaner assembly 10 creates flow through the solution extraction path 20, as shown in FIG. 12. The solution extraction path 20 extends from a suction inlet of the base 14 to the second tank 32. The solution extraction path 20 flows into the second tank 32, thereby storing the extracted cleaning solution and debris in the second tank 32. The second tank 32 is removable such that the contents therein can be disposed.

When the power source is charged, the power cord 66 is removed from the base 14, such that the vacuum cleaner assembly 10 can be operated cordlessly. A power button 28 on the handle causes power to be supplied from the power source to the motor, which drives the brush roll 22 and creates suction through the suction inlet in the base 14. The base 14 includes a plurality of wheels 15 rotatably connected thereto to facilitate pushing and pulling the wet vacuum cleaner assembly 10 during operation, as shown in FIGS. 1, 11 and 12. The brush roll 22 is movably disposed in the base 14, as shown in FIG. 12. The suction inlet is disposed in a bottom surface of the base 14 in association with the brush roll 22. The trigger 30 dispenses solution 74 from the first tank 32 to be dispensed through the solution distribution path 18, as shown in FIGS. 1 and 11, and sprayed from the base 14 by nozzles 76. Suction created by the motor draws up the dispensed solution through the suction inlet in the base 14. The solution extraction path 20 extends from the suction inlet in the bottom surface of the base 22 to the second tank 32, as shown in FIG. 12, where the extracted solution and debris is stored. The second tank 32 is removed from the housing 16 of the base 12 to dispose of the contents stored therein.

The power source is disposed in the vacuum body housing 16 and is configured to be connected to an external power supply, such as an electrical outlet, to charge the power source, as shown in FIG. 9. A power cord is connected between a port in the base 14 of the wet vacuum cleaner assembly 10 and the external power supply to supply power from the external power supply through the power cord to charge the power source. The port is electrically connected to the power source. The power cord is removed from the port and the external power supply when the power source is charged to a desired level. An indicator can be disposed on the vacuum body housing 16 to indicate when the power source is fully charged.

As shown in FIGS. 16-23, a floor cleaning apparatus in accordance with another illustrated exemplary embodiment of the present invention is substantially similar to the wet vacuum cleaner assembly 10 of the exemplary embodiment illustrated in FIGS. 1 to 15 except for the differences described below. Similar parts are identified with similar reference numerals, except increased by 200 (i.e., 2xx, accordingly).

As shown in FIGS. 16-23, a wet mop assembly 210 in accordance with another exemplary embodiment of the present invention includes a mop body 212 and a base 214. The base 214 is pivotably connected to the mop body 212 such that the body 212 can be held at any suitable angle with respect to the base 214.

The mop body 212 includes a housing 216 in which a power source (not shown) is disposed. The power source, such as a plurality of rechargeable batteries, is electrically connected to and supplies power to the first electrical contacts 242 in the tank receiving portion 236.

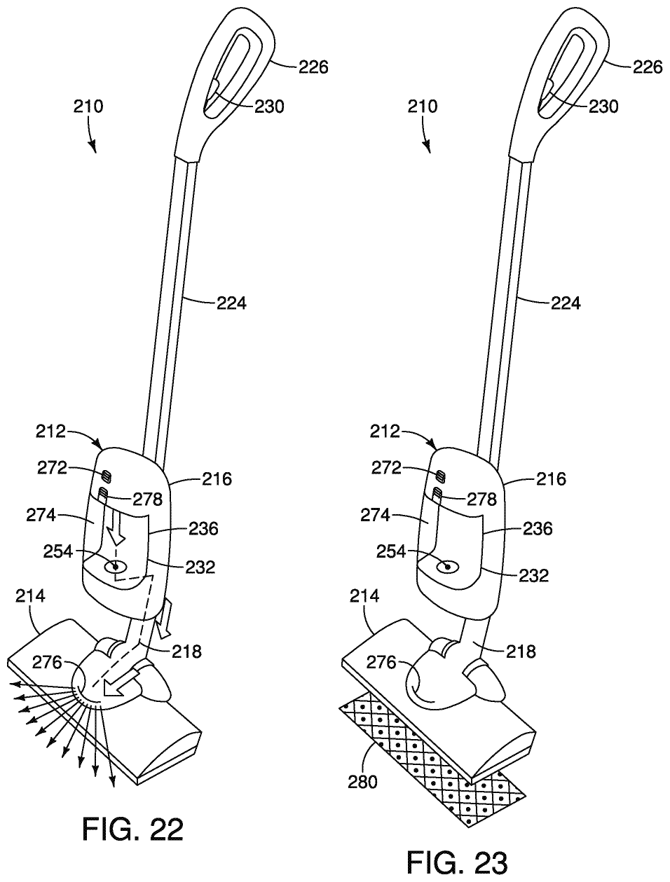

The mop body 212 includes a handle 224 extending from the housing 216 and includes a gripping portion 226 disposed at an upper end of the handle 224 to facilitate handling the wet mop assembly 210, as shown in FIG. 16. A trigger 230 is disposed on the handle 224. Operation of the trigger 230 dispenses cleaning solution 274 through a solution distribution path 218 and is sprayed out evenly through a plurality of nozzles 276 disposed in the base 214, as shown in FIGS. 16 and 22.

The housing 216 of the wet mop body 212 includes a tank 232, as shown in FIG. 16. Cleaning solution is produced and stored in the tank 232.

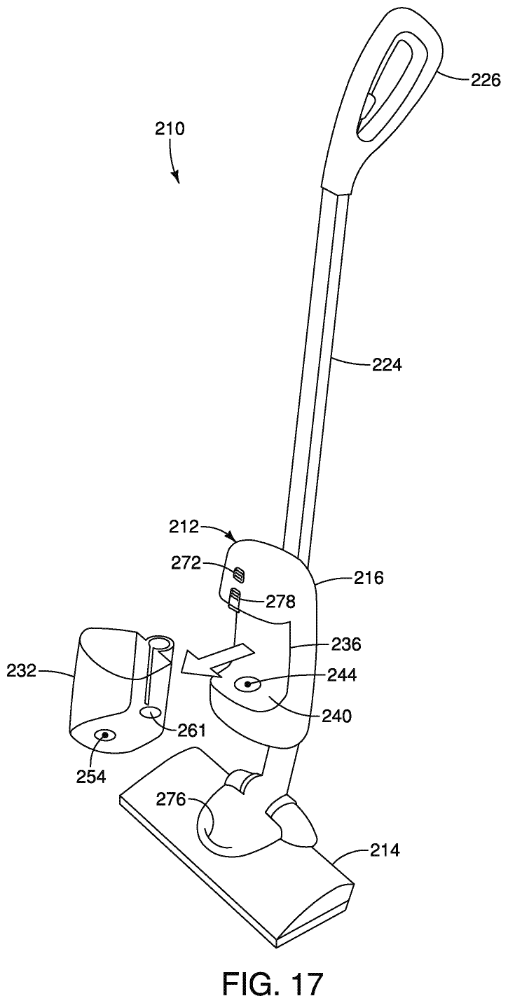

The housing 216 of the wet mop body 212 includes a tank receiving portion 236, as shown in FIGS. 16 and 17. The tank receiving portion 236 is a recessed portion in the housing 216 configured to removably receive the tank 232.

The tank receiving portion 236 includes a base 240, as shown in FIGS. 17 and 19. A first electrical contact 242 is disposed in the base 240. The first electrical contact 242 is illustrated as a pair of electrical contacts, but can have any suitable configuration. A port 244 is disposed in the base 240 and is in fluid communication with the solution distribution path 218, as shown in FIGS. 16 and 22.

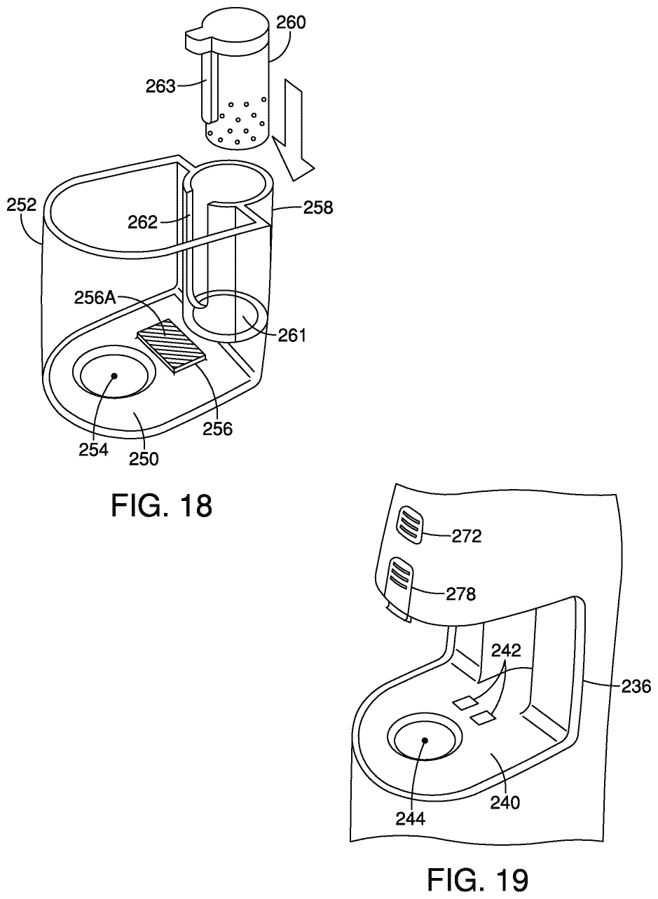

The first tank 232 includes a base 250 and a wall 252 extending upwardly from the base, as shown in FIG. 18. A port 254 in the base 250 of the tank 232 is aligned with the port 244 in the base 240 of the tank receiving portion 236, such that the tank 232 is in fluid communication with the solution distribution path 218 (FIGS. 16 and 22). A second electrical contact 256 is disposed on the base 250 of the tank 232. The second electrical contact 256 is electrically connected to the first electrical contact 242 when the tank 232 is received by the tank receiving portion 236. As shown in FIGS. 18 and 21, the second electrical contact 256 is disposed substantially planar to the base 250, such that the upper surface 256A is exposed. Alternatively, the second electrical contact 256 can be configured similarly to the second electrical contact 156 of the tank 132 shown in FIGS. 13-15.

The wall 252 includes a cylindrical wall portion 258, as shown in FIG. 18. The cylindrical wall portion 258 includes a base 261. A slot 262 extends linearly from the upper end of the cylindrical wall portion 258 towards the base 261. Preferably, the slot 262 does not extend to the base 261.

A cartridge 260 is configured to be received by the cylindrical wall portion 258 of the tank 232, as shown in FIGS. 18 and 21. A projection 263 extends outwardly from an outer surface of the cartridge 260 and has a shape corresponding to a shape of the slot 262, thereby ensuring proper alignment of the cartridge 260 with the tank 232. The cartridge 260 contains chemical elements, such as a saline solution. Alternatively, the cartridge 260 is removably received by the housing 216 of the vacuum cleaner body 212 such that the cartridge 260 is in communication with the tank 232. In other words, the cartridge 260 is received by the housing 216 externally of the tank 232.

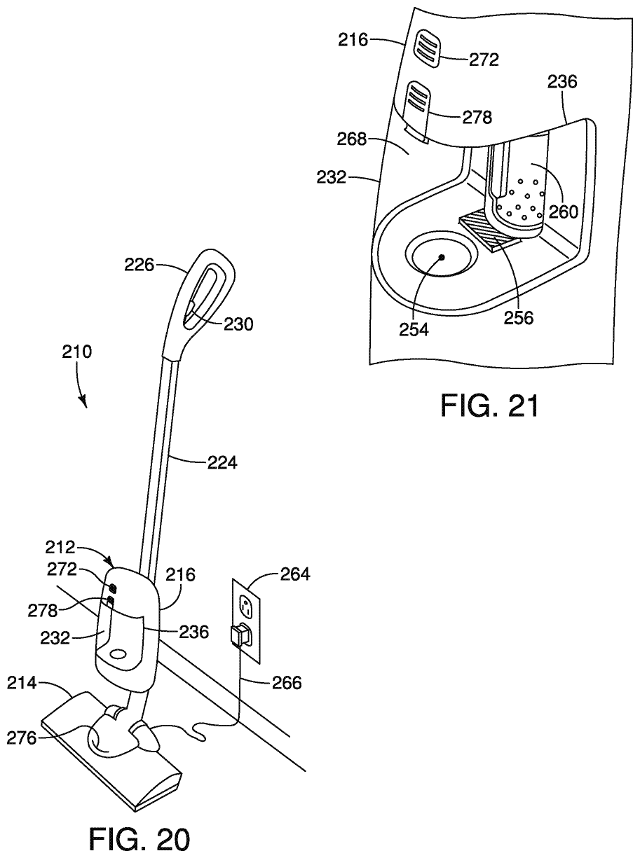

The power source is disposed in the vacuum body housing 216 and is configured to be connected to an external power supply 264, such as an electrical outlet, to charge the power source, as shown in FIG. 20. A power cord 266 is connected between a port in the base 214 of the wet mop assembly 210 and the external power supply 264 to supply power from the external power supply 264 through the power cord 266 to charge the power source. The port is electrically connected to the power source. The power cord 266 is removed from the port and the external power supply 264 when the power source is charged to a desired level. An indicator can be disposed on the vacuum body housing 216 to indicate when the power source is fully charged.

The tank 232 is removed from the tank receiving portion 236 to add a cartridge 260 to the tank 232. Pressing a locking button 278, as shown in FIG. 19, on the housing 216 allows the tank 232 to be removed from the tank receiving portion 236. When the cartridge 260 is received by the tank 232, water 268 is added to the tank 232 to a fill line 70 (FIGS. 6 and 7). The tank 232 is then positioned in the tank receiving portion 236, as shown in FIG. 21. The locking member 278 flexes to allow insertion of the tank 232, and then securely retains the tank 232 in the tank receiving portion 236 and prevents accidental removal of the tank 232, as shown in FIG. 21. An upper wall of the tank receiving portion 236 covers and seals the tank 232 to substantially prevent contents thereof from leaking or splashing out. The power cord 266 is connected between the wet mop assembly 210 and the external power supply 264. A solution producing button 272 is disposed on the housing 16 of the wet vacuum cleaner assembly 10, as shown in FIGS. 5 and 9.

When the power cord 266 supplies electrical power from the external power source 264 to the wet mop assembly 210, the solution producing button 272 can be pressed to produce cleaning solution 274 in the tank. Power is supplied to the second electrical contact 256 disposed in the first tank through the first electrical contact 242 in the housing 216 of the wet mop body 212. Power being supplied to the first electrical contact 242 causes the chemical elements in the cartridge 260 to be released into the tank 232. A projection disposed in the base 240 of the tank receiving portion 236 is caused to move upwardly and puncture a seal formed at the bottom of the cartridge 260. The puncture allows the chemical elements stored in the cartridge to leak into the first tank 232 and mix with the water 268 (FIG. 21) stored therein. The electrical power supplied to the second electrical contact 256 causes electrolysis to occur, thereby creating the cleaning solution 274 in the tank 232. For example, the cartridge 260 can contain a liquid saline solution, which is mixed with the water 268 stored in the tank 232. Electrolysis produces hypochlorous acid, which can be used as the cleaning solution 274 with the wet mop assembly 210. The cleaning solution 274 is produced in the tank 232 in the wet mop assembly 210, such that the cleaning solution does not need to added to the tank 232. When the wet mop assembly 210 is sufficiently charged and electrolysis is complete, the power cord 266 can be unplugged from the external power source 264 and the wet mop assembly 210, including the produced cleaning solution 274, is ready for operation. Alternatively, the cleaning solution can be produced without the wet vacuum cleaner assembly 210 being connected to the external power source 264 (FIG. 20). In other words, the cleaning solution can be produced when the wet mop assembly 210 is not being charged. The power required for electrolysis is supplied from the power source of the wet mop assembly 210.

The motor of the wet vacuum cleaner assembly 10 creates flow through the solution extraction path 20, as shown in FIG. 12. The solution extraction path 20 extends from a suction inlet of the base 14 to the second tank 32. The solution extraction path 20 flows into the second tank 32, thereby storing the extracted cleaning solution and debris in the second tank 32. The second tank 32 is removable such that the contents therein can be disposed.

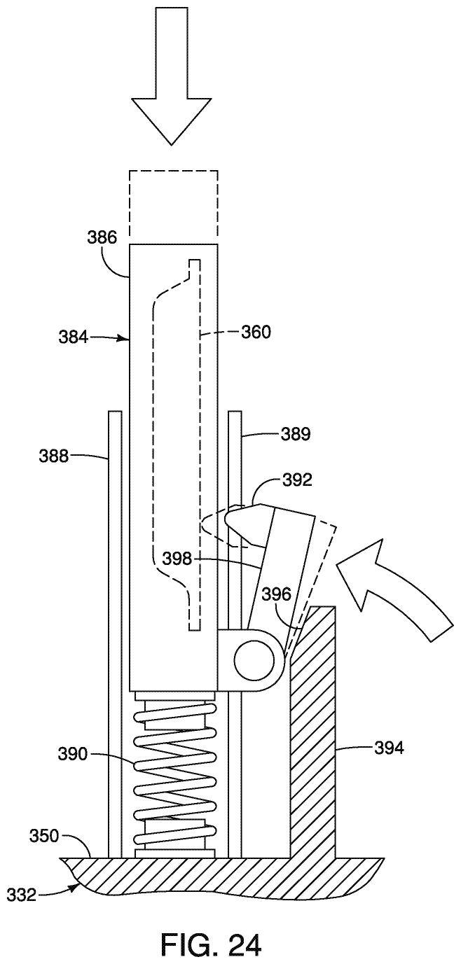

When the power source is charged, the power cord 266 is removed from the base 214, such that the wet mop assembly 210 can be operated cordlessly. A disposable cleaning pad 280 is connected to a lower surface of the base 214, as shown in FIG. 23. The trigger 230 dispenses cleaning solution 274 from the tank 232 to be dispensed through the solution distribution path 218, as shown in FIGS. 16 and 22, and evenly sprayed from the base 214 by nozzles 276. The cleaning solution sprayed on the surface to be cleaned is removed from the surface by the cleaning pad 280. The cleaning pad 280 is removed from the base 214 as appropriate and replaced with a fresh cleaning pad. The cleaning pad 280 is attached to the base 214 in any suitable manner.

The power source is disposed in the vacuum body housing 216 and is configured to be connected to an external power supply 264, such as an electrical outlet, to charge the power source, as shown in FIG. 20. A power cord 266 is connected between a port in the base 214 of the wet mop assembly 210 and the external power supply 264 to supply power from the external power supply 264 through the power cord 266 to charge the power source. The port is electrically connected to the power source. The power cord 266 is removed from the port and the external power supply 264 when the power source is charged to a desired level. An indicator can be disposed on the mop body housing 216 to indicate when the power source is fully charged.

As shown in FIG. 24, a puncture member 384 is illustrated in accordance with another illustrated exemplary embodiment of the present invention. Similar parts are identified with similar reference numerals, except increased by 300 (i.e., 3xx, accordingly).

The puncture member 284, as shown in FIG. 24, is mechanically activated. The puncture member 284 includes a support member 386 to which a projection 392 is movably connected. The cartridge 360 is received by the support member 386 movably connected to the base 350 of the first tank 332. A biasing member 390, such as a spring, is connected between the base 350 and the support member 386 to allow movement of the support member 386 relative to the base 350. First and second guide walls 388 and 389 extend upwardly from the base 350 and guide movement of the support member 386. An activating wall 394 extends upwardly from the base 350. The activating wall 394 has a ramped surface 396 facing the guide walls 388 and 389. A support arm 398 is movably connected to the support member 386. The projection 392 is connected to an end of the support arm 398. A biasing member can be connected to the support arm to bias the support arm to a position in which the projection is spaced from the support member 386.

When the first tank 332 is inserted in the first tank receiving portion 36 (FIG. 1), the support member 386 contacts the upper surface of the first tank receiving portion and is pushed downwardly against the force exerted by the biasing member 390. The downward force exerted on the support member 386 is indicated by the downward arrow in FIG. 24. When the support member 386 is pushed downwardly, the support arm 398 contacts the ramped surface 396 of the activating wall 394. The ramped surface 396 moves support arm 398 toward the support member 386, as indicated by the counter-clockwise arrow in FIG. 24, such that the projection 392 punctures the cartridge 360 disposed in the support member 386. The chemical elements stored in the cartridge 360 are then released through the punctured opening in the cartridge and into the water stored in the first tank 332.

Although the above exemplary embodiments are discussed with regard to the wet vacuum cleaner assembly 10 and the wet mop assembly 210, the present invention is equally applicable to any suitable floor cleaning apparatus, such as a wet mop assembly. The floor cleaning apparatus produces cleaning solution in the floor cleaning apparatus, such that cleaning solution does not need to be added to the floor cleaning solution prior to operation.

The foregoing detailed description of the certain exemplary embodiments has been provided for the purpose of explaining the principles of the invention and its practical application, thereby enabling others skilled in the art to understand the invention for various exemplary embodiments and with various modifications as are suited to the particular use contemplated. This description is not necessarily intended to be exhaustive or to limit the invention to the exemplary embodiments disclosed. Any of the exemplary embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “upper”, “below”, “lower”, “upward”. “upwardly”, “downward”, “downwardly”, “top”, “bottom”, “side”, “vertical”, “horizontal”, “perpendicular” and “transverse” as well as any other similar directional terms refer to those directions of a vacuum cleaner assembly in an upright position for use. Accordingly, these directional terms, as utilized to describe the floor cleaning apparatus should be interpreted relative to a floor cleaning apparatus in an upright position on a horizontal surface. The terms “left” and “right” are used to indicate the “right” when referencing from the right side as viewed from the rear of the vacuum cleaner assembly, and the “left” when referencing from the left side as viewed from the rear of the floor cleaning apparatus.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”. “connected”, “coupled”, “mounted”. “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the exemplary embodiments according to the present invention are provided for illustration only, and not for the purpose of limiting the invention as defined by the appended claims and their equivalents.

What is claimed is:

1. A floor cleaning apparatus, comprising:
a floor cleaning apparatus body;
a first tank removably received by the floor cleaning apparatus body;
a cartridge in communication with the first tank, the cartridge releasably storing chemical elements;
a first electrical contact disposed in the floor cleaning apparatus body; and
a second electrical contact disposed in the first tank, the second electrical contact being electrically connected to the first electrical contact when the floor cleaning apparatus body receives the first tank,
electrical power being configured to be supplied to the first electrical contact to release the chemical elements stored in the cartridge into water stored in the first tank, the supplied electrical power being configured to cause electrolysis of the water and the chemical elements in the first tank to produce a cleaning solution in the first tank.

2. The floor cleaning apparatus according to claim 1, wherein
the cleaning solution is a hypochlorous solution.

3. The floor cleaning apparatus according to claim 1, wherein
the chemical elements stored in the cartridge are different from the cleaning solution.

4. The floor cleaning apparatus according to claim 1, wherein
the floor cleaning apparatus is a wet vacuum cleaner.

5. The vacuum cleaner assembly according to claim 4, wherein
a second tank is removably received by the vacuum cleaner body.

6. The vacuum cleaner assembly according to claim 5, wherein
the first tank is not in fluid communication with the second tank.

7. The vacuum cleaner assembly according to claim 1, wherein
the floor cleaning apparatus is a wet mop.

8. The vacuum cleaner assembly according to claim 1, wherein
the cartridge is removably connected inside the first tank.

9. The vacuum cleaner assembly according to claim 1, wherein
the second electrical contact is substantially horizontally disposed in the first tank.

10. The vacuum cleaner assembly according to claim 1, wherein
the second electrical contact is substantially vertically disposed in the first tank.

11. The vacuum cleaner assembly according to claim 1, wherein
a power source is disposed in the floor cleaning apparatus body, the power source being configured to supply power to the first electrical contact.

12. The vacuum cleaner assembly according to claim 6, wherein
a base is movably connected to the floor cleaning apparatus body, a plurality of nozzles disposed in the base being configured to dispense the cleaning solution.

13. The vacuum cleaner assembly according to claim 12, wherein
the second tank is configured to receive the cleaning solution extracted from a surface on which the cleaning solution is dispensed.

14. The vacuum cleaner assembly according to claim 1, wherein
a puncture member is disposed in the first tank, the puncture member being configured to release the chemical elements stored in the cartridge.

15. A floor cleaning apparatus, comprising:
a floor cleaning apparatus body;
a first tank removably received by the floor cleaning apparatus body;
a second tank removably received by the floor cleaning apparatus body, the second tank not being in fluid communication with the first tank;
a cartridge removably connected to the first tank, the cartridge releasably storing chemical elements;
a first electrical contact disposed in the floor cleaning apparatus body; and
a second electrical contact disposed in the first tank, the second electrical contact being electrically connected to the first electrical contact when the floor cleaning apparatus body receives the first tank,
electrical power being configured to be supplied to the first electrical contact to release the chemical elements stored in the cartridge into water stored in the first tank, the supplied electrical power being configured to cause electrolysis of the water and the elements in the first tank to produce a cleaning solution in the first tank.

16. The floor cleaning apparatus according to claim 15, wherein
the cleaning solution is a hypochlorous solution.

17. The vacuum cleaner assembly according to claim 15, wherein
the second electrical contact is substantially horizontally disposed in the first tank.

18. The vacuum cleaner assembly according to claim 15, wherein
the second electrical contact is substantially vertically disposed in the first tank.

19. A cartridge assembly for use with a floor cleaning apparatus to produce a cleaning solution, comprising:
a cartridge configured to be removably received by the floor cleaning apparatus; and
chemical elements releasably stored in the cartridge, the chemical elements being configured to be released when the cartridge is received by the floor cleaning apparatus to produce the cleaning solution.

20. The cartridge assembly according to claim 19, wherein
the chemical elements are a liquid saline solution.
